(19) United States
(12) Patent Application Publication
(10) Pub. No.: US 2015/0156406 A1
(43) Pub. Date: Jun. 4, 2015

(54) PHOTOGRAPHING DEVICE AND METHOD

(71) Applicants: INVENTEC (PUDONG) TECHNOLOGY CORPORATION, Shanghai (CN); INVENTEC CORPORATION, Taipei (TW)

(72) Inventor: Yoxing CUI, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/273,692

(22) Filed: May 9, 2014

(30) Foreign Application Priority Data
Nov. 29, 2013 (CN) 201310627884.9

(51) Int. Cl. H04N 5/232; H04N 5/262

(52) U.S. Cl. CPC H04N 5/23216; H04N 5/2621; H04N 5/23293

(57) ABSTRACT

A photographing device and method are disclosed, in which after a photographing device catches a scene and before the scene is taken as a picture, a hand drawing is drawn around the scene, so that the taken picture comprises the caught scene and the hand drawing, whereby capable of drawing the hand drawing in the course of taking a picture and reduced the process for post-processing for the picture.

### BACKGROUND OF THE RELATED ART

1. Technical Field

The present invention relates to a photographing device and method, and particularly to a photographing device and method where a hand drawing process is used in the photographing process.

2. Related Art

A digital camera (DC) is transforming optical image into electronic data by using an electronic sensor, contrary to a traditional camera which generates a picture by using a light ray on a negative.

In a digital camera, a photographing module, such as a photosensitive charge coupling device or a complement metal oxide semiconductor (CMOS) sensor, is used to acquire a scene. The scene acquired by the photographing module is encoded by using a particular algorithm, and stored as an image in a digital storing device, such as a memory card or a micro-hard disk.

The digital camera will generate a picture when photographing and the picture is then stored at a digital storing component of the camera. Thus, in the case that a user expects to edit the taken picture, e.g. add image, lines, circles or drawings in the picture, it will be necessary to read out the picture from the digital storing component in the camera, and an image processing software is used to process the picture. Only by this, lines, circles or drawings added to the picture.

If the user merely expects to add a simple drawing to the generated picture, the mentioned process may be too complicated and tiresome, and the user may further need to learn how to use the image processing software for processing.

In view of the above, it is known that there is an issue of adding drawings to the generated picture when photographing. Therefore, there is quite a need to set forth an improving technique to solve this issue in the prior art.

### SUMMARY

In view of the issue of adding some drawings to the taken scene when photographing, the present invention discloses a new photographing device and method.

According to the present invention, the photographing device comprises a photographing module, catching a scene; a drawing module, drawing a hand drawing around the scene on the displaying screen; and a displaying module, displaying a picture on the displaying screen, and the picture which contains the scene and the hand drawing.

According to the present invention, the photographing method for a photographing device comprising a photographing module and a displaying screen, comprising steps of catching a scene from the photographing device; drawing a hand drawing on the scene on the displaying screen; taking a picture which contains the scene and the hand drawing by the photographing module; and displaying the picture on the displaying screen.

The photographing device and method of the present invention has the advantage that before the scene is taken as the picture, a hand drawing is used on the scene, so that the picture comprises the caught scene and the drawn hand drawing, whereby solving the issue encountered in the prior art and enhancing the efficacy of processing for the picture.

### BRIEF DESCRIPTION OF THE DRAWINGS

The invention will become more fully understood from the detailed description given herein below illustration only, and thus is not limitative of the present invention, and wherein:

FIG. 1 is a schematic diagram of components of a photographing device according to the present invention;

FIG. 2 is a flowchart of a photographing method according to the present invention; and

FIG. 3A through FIG. 3C are schematic diagrams illustrating a continuous hand drawing process in the course of taking the picture according to an embodiment of the present invention.

### DETAILED DESCRIPTION OF THE INVENTION

The present invention will be apparent from the following detailed description, which proceeds with reference to the accompanying drawings, wherein the same references relate to the same elements.

By implementing the present invention, a user may draw a hand drawing on a scene before taking a picture, and then the scene and the hand drawing displayed on the displaying screen.

It is to be particularly noted that the “scene” is merely an image caught before the photographing device takes the picture. For example, a user open the photographing device, the photographing module catches an image, when the photographing device changes its place, the image the photographing module caught is also changed, this image is termed as the “scene”, when the user determined which image to catch, the user touch the photographing component or other elements, then a picture is taken. Before the user touch the photographing component, the photographing device still has not taken the picture, that is to say, the photographing device has not stored the acquired image as a picture.

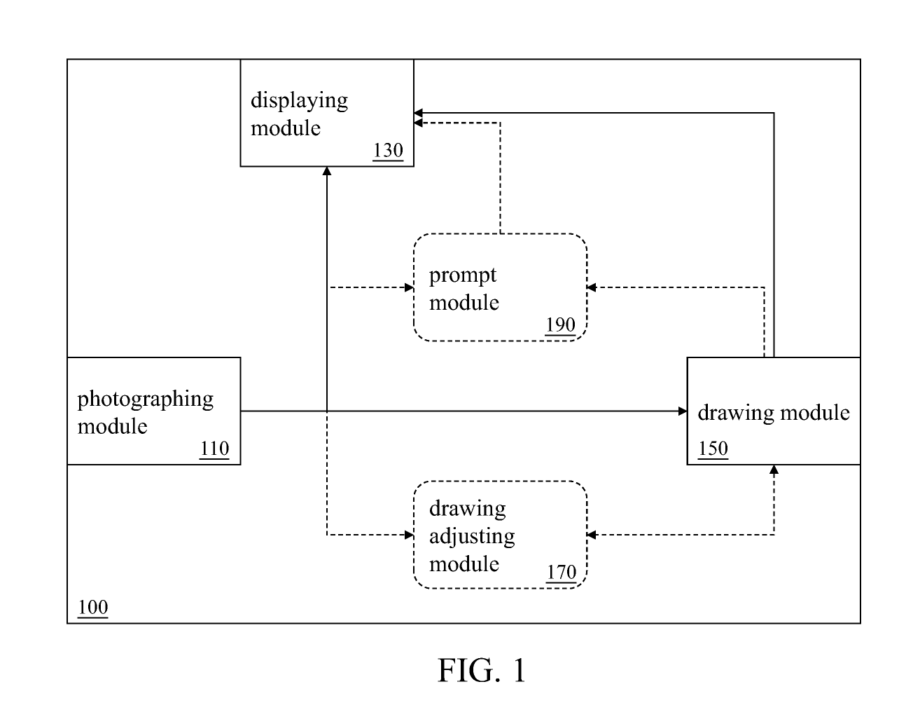

Referring to FIG. 1, in which a schematic diagram of components of a photographing device according to the present invention is illustrated. As shown, the photographing device 100 of the present invention comprises a photographing module 110, a displaying screen 130 and a drawing module 150.

Similarly to the prior art, the photographing module 110 has two stages for photographing. The first stage is to catch a scene, and the second stage is to take a picture from the scene. The difference to the prior art is that the photographing module 110 only generates the picture after the drawing module 150 draws the hand drawing around the caught scene, and the picture comprises the caught scene and the drawn hand drawing.

The displaying module 130 displays the scene caught by the photographing module 110, and also displays the picture taken by the photographing module 110.

The drawing module 150 draws a hand drawing around the scene displayed by the displaying module 130.

Typically, the drawing module 150 may provide the user to draw the hand drawing around the scene. For example, when the displaying module 130 is a touch screen, the drawing module 150 provides the user to draw the hand drawing around the displayed scene on the touch screen. The drawing module 150 may also comprise an established image database including one or more drawings, provide the user to choose one of the prepared drawings and add the chosen drawing to the scene, so that the user may zoom in, zoom out or rotate the chosen drawing on the scene.

The drawing module 150 may delete the hand drawing drawn around the scene, and draw another hand drawing on the scene. Further, the drawing module 130 may also draw a new hand drawing around the picture displayed by the displaying module 130.

In addition, the present invention may further comprise a drawing adjusting module 170 and a prompt module 190.

The drawing adjusting module 170 adjusts the hand drawing drawn by the drawing module 150, such as zooming in or out the hand drawing and/or adjusting a position of the hand drawing. However, the adjustment made by the drawing adjusting module 170 on the hand drawing is not only limited as the examples.

In some embodiments, the drawing adjusting module 170 may analyze the scene caught by the photographing module 110, so as to obtain the information of the scene, such as the composition of the scene, without limiting the present invention. The drawing adjusting module 170 may adjust the hand drawing drawn according to the information of the scene. For example, when the hand drawing drawn by the drawing module 150 overlaps in a foreground of the scene, the drawing adjusting module 170 zooms in or rotates the hand drawing, or moves the hand drawing to another place of the scene, so that the hand drawing drawn will not overlap in the foreground of the scene. However, the drawing adjusting module 170 determines and adjusts the hand drawing drawn by the drawing module 150 is not only limited as the above mentioned.

The prompt module 190 may show the user a position and/or angle of the hand drawing drawn by the drawing module 150. Similarly to the drawing adjusting module 170, prompt module 190 may analyze the scene caught by the photographing module 110, so that the information of the scene is acquired, and according to the acquired information, the drawing module 150 generates the prompt of the hand drawing drawn. For example, when the hand drawing drawn by the drawing module 150 overlaps in a foreground of the scene, the prompt module 190 generates a prompt of the hand drawing for moving or zooming in, and the prompt is displayed by the displaying module 130. However, the prompt generating manner of the prompt module 190 is not limited to the example.

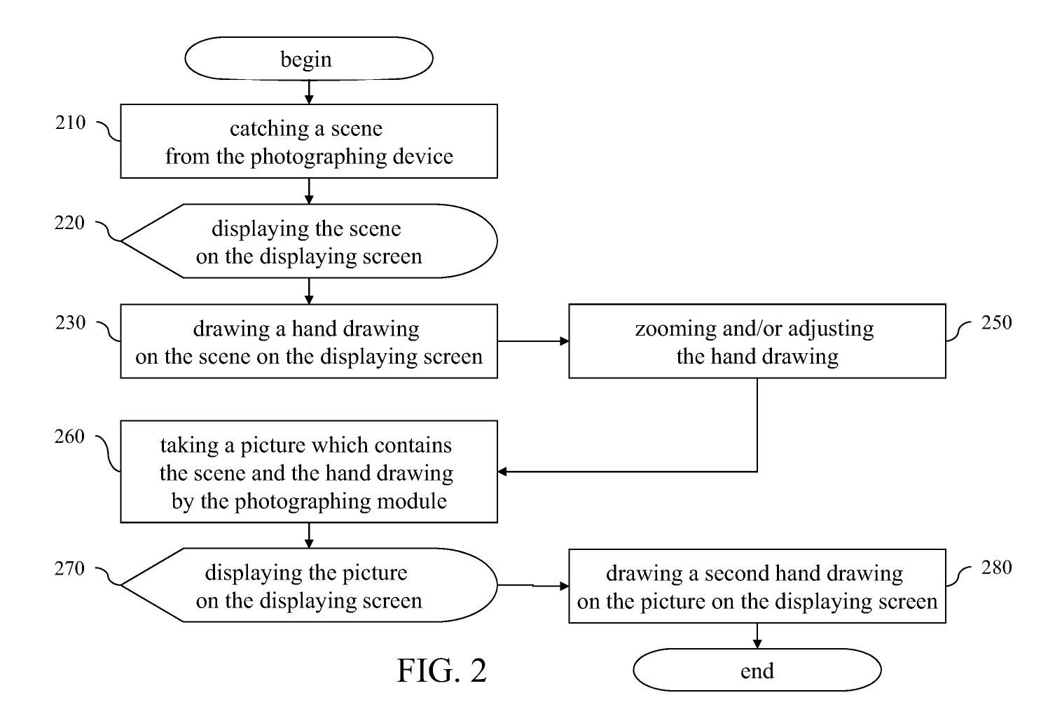

Thereafter, an embodiment is set forth to explain how the present invention is operated with reference to FIG. 2, in which a flowchart of the photographing method is illustrated.

The user begins to use the photographing device 100 of the present invention, the photographing module 110 in the photographing device 100 catches a scene (S210), and the displaying module 130 displays the scene caught by the photographing module 110 (S220). In this embodiment, assume the photographing module 110 is a camera, and the displaying screen is a touch screen.

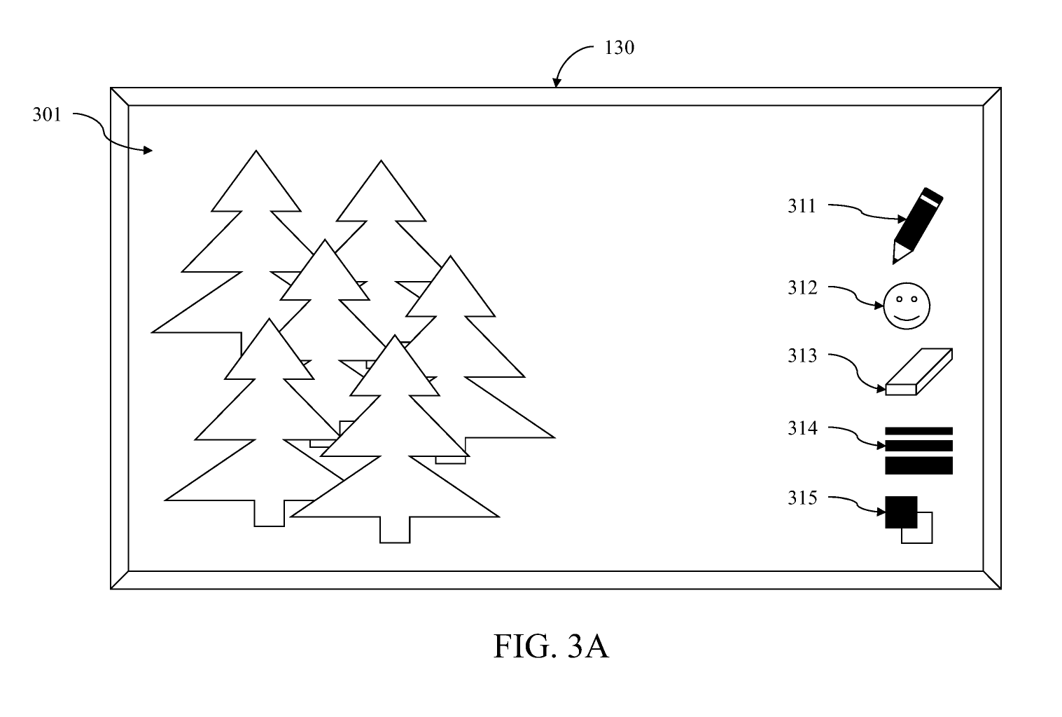

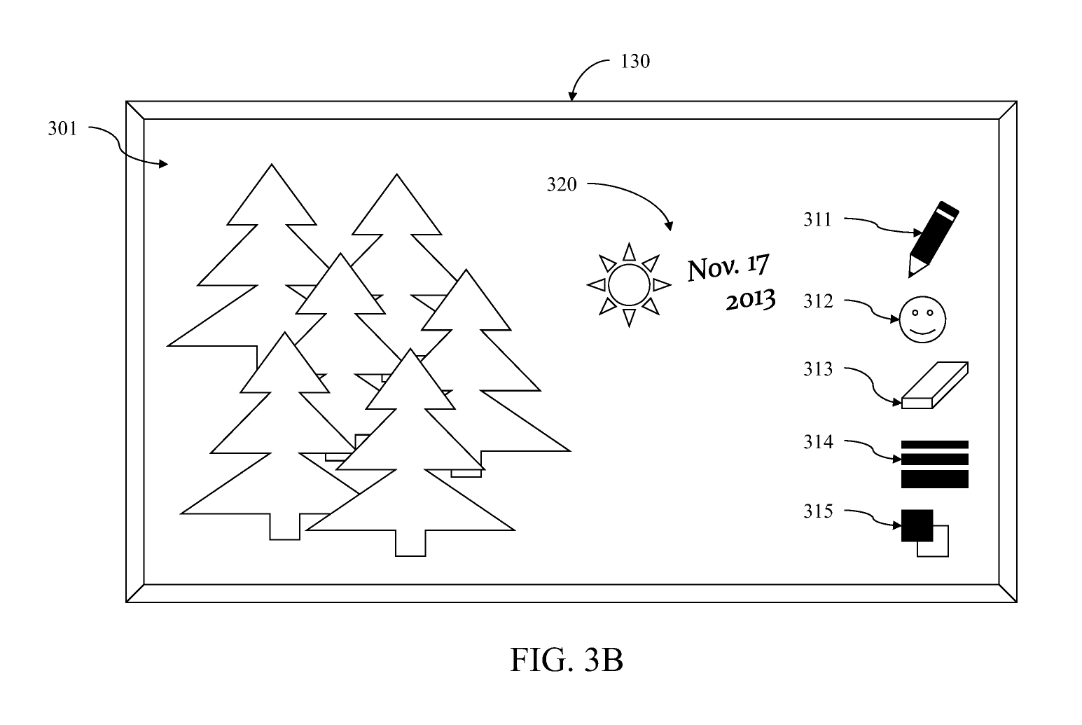

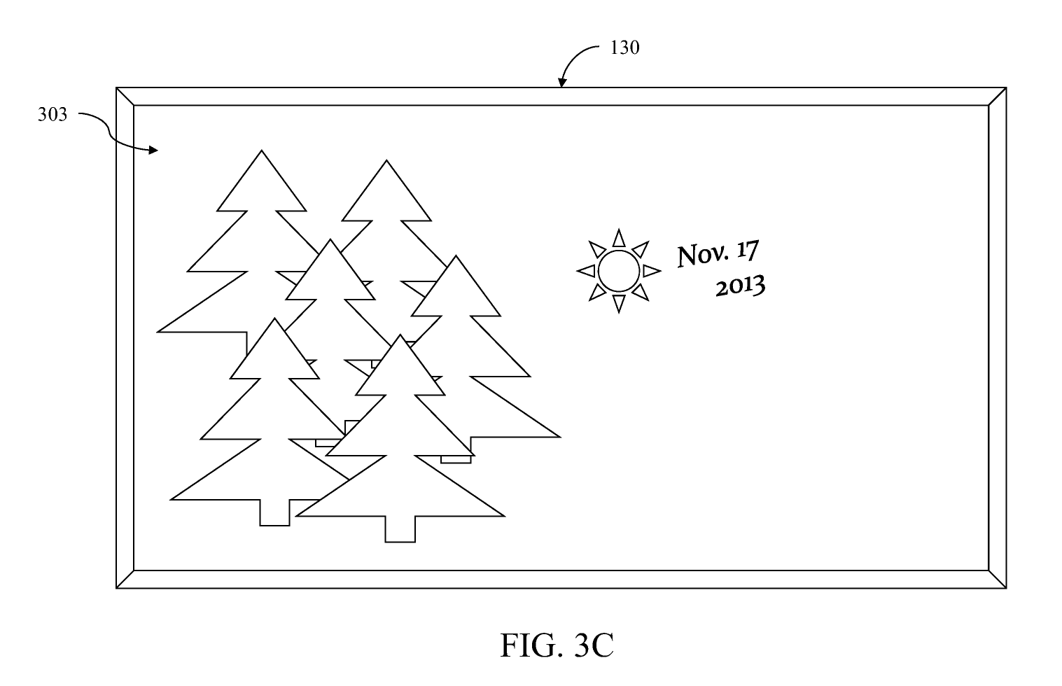

As shown in FIG. 3A, after the displaying module 130 displays the scene 301 (S220), if the user wishes to include a hand drawing, the drawing module 150 may provide the user to draw a hand drawing (first hand drawing) on the scene displayed on the displaying screen (S230).

In this embodiment, assume the drawing module 150 may display icons for the user to draw hand drawing by selecting one among the icons. For example, the icons may be a hand drawing function icon 311, a drawing selection function icon 312, a drawing deletion function icon 313, a brush thickness selection icon 314, a brush color selection icon 315, etc. The user may first select the hand drawing function icon 311, and then directly draw hand drawing around the scene displayed on the displaying screen, for example drawing a pattern or writing down a text, such as words or date.

The drawing module 150 may transform traces of the drawn hand drawing into a vector graph, and generating drawing information such as a position and/or color of the vector graph. And, the displaying module 130 displays the vector graph on the scene according to the drawing information. As such, the user may view the hand drawing 320 drawn previously through the scene 310 displayed on the displaying screen, as shown in FIG. 3B.

If the user is not satisfied with the hand drawing, the drawing module 150 may provide the user to delete the hand drawing. For example, the user may make some touches or a long time touch on the drawn hand drawing or the written text. Or, the user may delete the drawing or text he touched after touching the drawing deletion function icon 313. The drawing module 150 may display a conversation window on the displaying module 130 for confirming the deletion. When the user confirms the deletion, the drawing module 150 deletes the previous hand drawing. In this manner, the scene displayed by the displaying module 130 will not have the deleted hand drawing.

After the graph drawing module 150 deletes the hand drawing, the drawing module 150 may provide the user to draw a new hand drawing (second hand drawing) on the scene (S230).

After the user completes the hand drawing 320 on the scene 301 through the drawing module 150 (S230). The user triggers a camera shutter of the photographing device 100, so that the photographing module 110 takes the scene 301 as a picture 303 (S260). In this embodiment, the user may press a particular button of the photographing device 100, or touch a particular area on the displaying screen to trigger the camera shutter.

After the photographing module 110 takes the picture 303 (S260), the picture 303 displayed by the displaying module 130 contains the caught scene 301 and the drawn hand drawing 320 (S270). As such, the user may add the hand drawing 320 to the picture 303 when photographing, without requiring a post-processing on the picture 303.

In the above mentioned embodiment, if the photographing device 100 further includes the drawing adjusting module 170, the drawing adjusting module 170 may adjust the hand drawing 320 (S250) after the drawing module 150 draws the hand drawing 320 around the scene 301. In this embodiment, assume the drawing adjusting module 170 may zoom in the hand drawing 320, adjusting the position of the hand drawing 320 and/or rotating the position of the hand drawing 320, i.e. the drawing adjusting module 170 may also zoom in or adjust the written text.

After the picture 303 comprising the scene 301 and the hand drawing 320 is generated (S270), if the user still expects to draw a hand drawing in the picture 303, the drawing module 160 may provide the user to draw a new hand drawing (second hand drawing) around the picture 303 displayed on the displaying screen (S280). In this embodiment, the drawing module 150 may also display all of the function icons said above on the displaying screen for drawing the new hand drawing.

In view of the above description, the photographing device and method of the present invention has the advantage that after the scene is caught and before the scene is taken as a picture, a hand drawing is used on the scene, so that the taken picture comprises the caught scene and the hand drawing, whereby solving the issue encountered in the prior art and reduced the post-process for the picture.

Furthermore, the present invention may be implemented in hardware, software or a combination thereof. Alternatively, the method may also be implemented in a single unit or separate computer systems connected with discrete components arranged therein.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A photographing method for a photographing device comprising a photographing module and a displaying screen, comprising steps of:
catching a scene from the photographing device;
drawing a hand drawing on the scene on the displaying screen;
taking a picture which contains the scene and the hand drawing by the photographing module; and
displaying the picture on the displaying screen.

2. The photographing method as claimed in claim 1, further comprising a step of zooming the hand drawing on the scene on the displaying screen after the hand drawing drew on the scene.

3. The photographing method as claimed in claim 1, further comprising a step of adjusting a position of the hand drawing on the scene on the displaying screen.

4. The photographing method as claimed in claim 1, further comprising a step of drawing a second hand drawing on the picture on the displaying screen.

5. The photographing method as claimed in claim 1, wherein the step of drawing the hand drawing on the scene further comprises a step of:
choosing the hand drawing from an established image database of the photographing device.

6. The photographing method as claimed in claim 1, wherein the step of drawing the hand drawing on the scene further comprises a step of:
showing a prompt for a position or angle of the hand drawing on the displaying screen.

7. The photographing method as claimed in claim 1, further comprising steps of deleting the hand drawing, and drawing a second hand drawing on the scene on the displaying screen.

8. A photographing device, comprising:
a photographing module, catching a scene;
a drawing module, drawing a hand drawing around the scene; and
a displaying module, displaying a picture on the displaying screen after the photographing module takes the picture which contains the scene and the hand drawing.

9. The photographing device as claimed in claim 8, further comprising a drawing adjusting module for zooming the hand drawing.

10. The photographing device as claimed in claim 8, further comprising a drawing adjusting module for adjusting a position of the hand drawing on the scene.

11. The photographing device as claimed in claim 8, wherein the drawing module further draws a second hand drawing on the picture displayed by the displaying module.

12. The photographing device as claimed in claim 8, wherein the drawing module further comprising an established image database including at least one prepared drawing, and the drawing module choosing one of the prepared drawing and putted the chosen drawing on the scene on the displaying screen.

13. The photographing device as claimed in claim 8, further comprising a prompt module for generating a position or an angle of the hand drawing before the drawing module draws the hand drawing.

14. The photographing device as claimed in claim 8, the drawing module further deletes the hand drawing and draws the second hand drawing on the scene on the displaying screen.
